(19) United States
(12) Patent Application Publication
(10) Pub. No.: US 2009/0111375 A1
(43) Pub. Date: Apr. 30, 2009

(54) AUTOMATIC WIRELESS PHOTO UPLOAD FOR CAMERA PHONE

(75) Inventors: Stephen S. Burns, Loveland, OH (US); Thaddeus M. Bort, JR., Maineville, OH (US)

Correspondence Address: WOOD, HERRON & EVANS, LLP, 2700 CAREW TOWER, 441 VINE STREET, CINCINNATI, OH, 45202, US

(73) Assignee: ITOOKTHISONMYPHONE.COM, INC., Cincinnati, OH (US)

(21) Appl. No.: 12/257,871

(22) Filed: Oct. 24, 2008

Related U.S. Application Data
(60) Provisional application No. 60/982,302, filed on Oct. 24, 2007.

(51) Int. Cl. H04H 40/00; H04W 4/12

(52) U.S. Cl. 455/3.06; 455/466

(57) ABSTRACT

A method, apparatus, and program product are provided for transmitting media objects from a mobile device to a server. A DeviceSide component is executed on the mobile device that does not require user intervention. A new media object is detected by the DeviceSide component. The new media object is processed by the DeviceSide component and automatically transmitted to the server. A ServerSide component on the server is configured to receive the media object automatically detected and transmitted by the DeviceSide component on the mobile device. The received media object is processed, and a notification of the received media object is transmitted to the mobile device.

### CROSS-REFERENCE TO RELATED APPLICATIONS

This claims the filing benefit of co-pending U.S. Patent Application Ser. No. 60/982,302, filed Oct. 24, 2007, the disclosure of which is hereby incorporated herein by reference in its entirety.

### FIELD OF THE INVENTION

This invention relates to applications for a mobile phone with an integrated camera and more particularly to applications that upload photos, videos, or other media objects from the phone to a server.

### BACKGROUND OF THE INVENTION

Mobile-friendly technologies are capable of providing a rich multimedia environment and enhance the wireless device users' experience. An outcome of this evolution is the manifest closeness between the wireless universe and the Internet domain, as well as the advent of wireless devices with multimedia capabilities. The newest versions of mobile wireless devices such as digital mobile phones, pagers, personal digital assistants (PDAs), handsets, and any other wireless terminals, have multimedia capabilities including the ability to retrieve e-mail, and push and pull information via the Internet.

Contemporary cellular telephones may be configured similarly to wireless devices, providing any and all of the conventional functions of wireless devices. Two popular features of contemporary cellular phones are still and video cameras. Among many improvements to the still and video cameras are higher resolution features, such as cameras having resolution in the mega-pixel range, over one million pixels per square inch. Still photos in this resolution range require substantial storage capacity. Such capacity generally quickly fills up, particularly when a user is on vacation, taking many photos. Video motion pictures require even more storage space. To overcome this problem, many users carry extra storage devices, laptops, and other devices just to capture enough data to preserve the video or photos. This is inconvenient, cumbersome and expensive. Alternatively, users can e-mail their photos or manually upload them to the Internet if the phone is properly equipped. Once uploaded, users may need to further manipulate the photos or videos in order to share with friends or relatives.

What is needed therefore is an automated method to upload and organize photos, videos, and other media objects from the cellular phone or other mobile device.

### SUMMARY OF THE INVENTION

A method, apparatus, and program product are provided for transmitting media objects from a mobile device to a server. A DeviceSide component executes on the mobile device and does not require user intervention. A new media object is detected by the DeviceSide component which processes the new media object. The processed media object is then automatically transmitted to a server by the DeviceSide component.

In some embodiments, the new media object is processed by dividing the new media object into a plurality of raw data segments. Header identification data is added to each of the plurality of raw data segments. Transmission of the plurality of raw data segments occurs over a data connection to the server. The data connection includes connections such as a TCP connection, SSL based TCP connection, UDP connection, Multimedia Messaging Service (MMS), Simple Messaging Service (SMS), or combinations thereof. In a particular embodiment, GPS coordinate data is retrieved and associated with the new media object. In this embodiment, the GPS coordinate data is automatically transmitted with the processed media object to the server by the DeviceSide component.

The processed media object is received by a ServerSide component on the server. In some embodiments, the received media object is processed by the ServerSide component. After successful processing, the ServerSide component notifies the DeviceSide component on the mobile device of the receipt of the media object. The ServerSide component then stores the received media object. When storing the received media object, for some embodiments, the received media object is stored in a preselected album on the server. Additionally, when storing the received media object, in some embodiments, a privacy level for the received media object is established. The privacy level may be defined by the user prior to transmitting the media object to the server or the privacy level may be defined by the album in which the received media object is stored.

In some embodiments, the processed media object is received by the ServerSide component on the server. The received media object is processed by the ServerSide component and a notification of the received media object is transmitted to the mobile device. Additionally in these embodiments, the received media object is transmitted by the ServerSide component to a third party location.

In some embodiments, the new media objects are queued for processing by the DeviceSide component. Unsuccessful transmission of a media object may result in that media object being re-queued for processing.

In some embodiments, the automatic transmission of the processed media object may be disabled necessitating manual selection of the processed media object for transmission. The DeviceSide component may also be disabled.

In some embodiments a username and password is supplied to the DeviceSide component. The username and password is transferred to the server prior to transmitting the processed media object. Transmission of the processed media object may be prevented in response to receiving an invalid username or password.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a flowchart of the process for uploading media objects to a server.

FIG. 2 is a flowchart of a process for uploading and transferring media object to third party services.

FIG. 3 is a flowchart of a ServerSide component of FIG. 2.

FIG. 4 is a block diagram of an exemplary Server/Third Party interface for the ServerSide component in FIGS. 2 and 3.

FIG. 5 is a diagram illustrating the process of uploading media objects to a server in FIG. 1.

FIG. 6 is a diagram illustrating an initialization and a verification process on the server.

FIG. 7 is a diagram illustrating a process with a subscription service.

FIG. 8 is a diagram illustrating the process in FIG. 1 with GPS location.

FIG. 9 is a block diagram of an exemplary hardware and software environment for a computer suitable for implementing server based modules for the process in FIG. 1 consistent with embodiments of the invention.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

Embodiments of the present invention comprise two basic components. A first component resides on a cell phone or other similar mobile wireless device (“DeviceSide”) and a second component, which includes a suite of server based modules, which resides on a server (“ServerSide”). The DeviceSide component may be written in languages that the native device hardware can support, such as C++, Symbian, Java, Linux, among others.

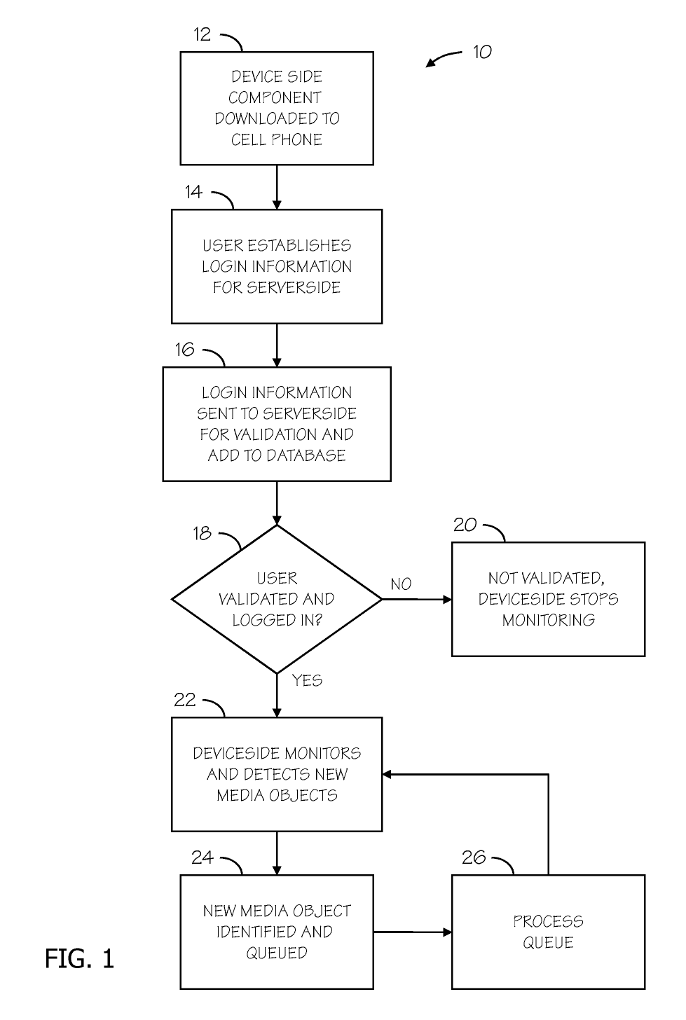

Turning to the drawings, wherein like numbers denote like parts throughout the several views, FIG. 1 shows flowchart 10 illustrating an embodiment of a process for uploading media objects, such as photos or videos, from the DeviceSide to the ServerSide applications. First, the DeviceSide component is downloaded over the air through the Internet or is downloaded via a software synchronization process to the cell phone or other mobile device (block 12). When the DeviceSide component is run for the first time a user will be prompted to establish and enter their login information (block 14). If the user has not yet registered, the user is then directed to complete a registration process. When the user registers, their information is sent to the ServerSide to be validated and added to the database (block 16).

The information transferred may include the user's username and password. After a user is registered they can log in to the ServerSide component at anytime. When a user logs in their information is sent to the ServerSide component to be validated. If the user cannot be validated (“No” branch of decision block 18), then a message is sent to the DeviceSide component to stop further transmissions (block 20). If the user is validated (“Yes” branch of decision block 18), then the DeviceSide application executes in the background with no further interaction from the user.

In some embodiments, the DeviceSide component runs as a background process in the form of a listener or a service that detects when new media objects have been written to the file system by the camera (block 22). When the listener receives a notification for a new photo or media object, it adds the photo to a queue (block 24) and ensures that the queue is being processed (block 26). As the queue is processed, each photo or media object is broken up into raw data and transmitted over a data connection to the server.

The data transmission includes but is not limited to TCP data communications available on the device. In some cases TCP data communication is not available and so another means of communication is required. Embodiments of the invention include the use of TCP communications, SSL based TCP communications, UDP communications, Simple Messaging Service (SMS), and Multimedia Messaging Service (MMS), among others.

In certain embodiments, the message containing the media object is broken down into smaller pieces, generally not to exceed the total length of a standard fixed message. These smaller messages may then be transmitted using any of the transmission protocols above. In some embodiments, during the configuration of consumer level phones, the DeviceSide component may initially check for a TCP connection. If it cannot establish this connection, the DeviceSide component may then revert to sending via MMS and if not MMS, via SMS if possible, based on the carrier allowance.

Messages may be transmitted including a header that is sent on every connection to the ServerSide component. A typical header definition, for some embodiments, contains field delimiters such as <USER>username</USER>, <Password>mypassword</Password>, and <PhoneNumber>555-555-1212</PhoneNumber>. The ServerSide component parses the header data token-by-token and connects to a database to validate that the user information supplied in the header is accepted. The ServerSide component transmits an <ACK> or a <NAK> back to the DeviceSide component through the same connection. When the ServerSide component responds with a <NAK>, the connection is terminated by the ServerSide component by closing the TCP connection and shutting down the instance. The photo or other media file is added to a persistent queue upon receiving the <NAK>. The image data ID is held in the queue and the DeviceSide component periodically retries the transmission.

If the ServerSide component responds with an <ACK>, the ServerSide component looks to begin receiving the messages containing the photo or other media file. The data in the messages is preceded by an image filename with the tag <FileName> that is generated by the ClientSide component based on the filename stored on the user device (cell phone or other mobile device). Following the </FileName> tag is an <ImageData> tag followed by a stream of data which begins its transmission. The data containing the photo or other media is sent to the server and the server opens a file based on a GUID or other unique identifier associated with the <FileName> tag in a folder associated at the server level with the account username. The ServerSide component continues to write the data out to a file until it receives the tag </ImageData>. At this point it transmits another <ACK> back to the DeviceSide component to acknowledge that the data has been transmitted successfully. In some embodiments the header definition could include GPS coordinates if the device supports it and the user has opted to send them with each media item. Geo-tagging of photos and videos may allow users to see a graphical representation of where each photo or video was taken.

After the message is successfully transmitted, the ServerSide component transmits a notification to the DeviceSide listener service indicating success or failure. If the DeviceSide listener receives a notification indicating success, the DeviceSide listener will continue to look for additional media objects in the queue and transmit them or wait for another media object to become present. If the DeviceSide listener receives a failure notification, the DeviceSide component will hold the media object and retransmit the media object in a set interval period until the image successfully transmits.

The image name is stored in a local DeviceSide persistent data store managed at the device level. The store can be a file or a shared memory object. It generally contains the filename and last transmission time indicating how often a transmission attempt has been made to the server and to assure that the images are transmitted in the appropriate order.

A third possible response from the ServerSide component is a service cancellation notification. In some embodiments, the ServerSide application may be configured as a fee based service where a user pays a fee at some interval to use the application. If the DeviceSide component receives a service cancellation notification, the DeviceSide component marks the service as cancelled and will prevent the DeviceSide listener from sending additional media objects. When cancellation is determined by the ServerSide component, the ServerSide responds with a <CXL> response. The DeviceSide Component receives the <CXL> message, terminates the transmissions, and clears the queue. Only after the login is reestablished will the DeviceSide component be allowed to send media objects again.

In some embodiments, SMS or MMS messaging transfers may be utilized. In cases where devices do not allow for data to be transmitted across a data channel, the photo or media object and account information may be transmitted across a basic email channel. The same basic structure as described above is used to send to the server, however, internal messages based on the operating system messaging APIs are generated to transmit the data to the server. In most cases, the messages can be transmitted to an SMS or MMS gateway service that can transmit the messages to the ServerSide component. The messages may be constructed using the same methodology as described above.

Messages are broken down by size limited blocks according to the transmission mechanism. Because a continuous socket is generally not possible, an ordering tag is transmitted in conjunction with the image data with each message. As the data and each message are transmitted, the header may also include a <FileNameID> tag identifying the filename and the message order, in case messages are received out of order by the server. For example, a message may be received with <FileNameID>kids.jpg-2</FileNameID>. The messages may be received out of order, so next message might be kids.jpg-4. The ServerSide components will hold this file until it receives kids.jpg-3. In some embodiments, a soft timeout is built in so that if kids.jpg-3 is not received in a set time, the ServerSide component will send a message back to the device indicating the <NAK> sequence.

The DeviceSide component includes a message listener, which is operable to look for an application specific tag, such as <ITookTOMP/>, that is parsed on every MMS or SMS message as they are received. If the tag is present, then the email is handed to the ClientSide component. If the tag is not present, the message is left in the messaging system for user review.

In addition to the background process, the DeviceSide component also contains an application interface used to set configuration information for the application. From this interface, the user may enable or disable the application. The user may also set whether their photos or videos may be viewed by others or if the photos or videos are private and only viewable by the user. The user may choose through the interface whether or not to be prompted when uploading each photo or media object, whether or not to send GPS coordinates, if available, or select the album that the user would like their photos or videos to be added.

In some embodiments, the DeviceSide component allows for manual uploading of media objects in addition to the automatic uploading. Using the manual upload, the user can select from all of the media objects currently on the device's internal memory or external memory and upload those selected files to the server. When the media objects are selected, the DeviceSide component adds them to the queue and follows the same process as with automatic uploading to send them to the server as described above. Additionally, and in some embodiments, the DeviceSide component allows the user to configure a parameter to allow the user to delete the images after they have successfully been transmitted. If this flag is marked, then the images are removed from the device's local storage once a successful <ACK> has been received.

Another parameter allows the user to mark images as public or private. This allows the user to control whether anyone who logs onto a website as either a guest or a registered user can view the media objects. Media objects may be loaded into a featured or public location where users can search or view by categories such as Most Viewed, Featured, or Searchable.

In some embodiments, the user may also configure the DeviceSide component to prompt the user every time a photo is taken to determine if the user wants to upload the image. If the user indicates that they do not want to upload the image, the image is immediately eliminated and released and not added to the queue for transmittal. The prompt generally occurs when the DeviceSide listener determines there is a new image. The listener displays the filename to the user for a determination before handing the file to the queue.

In some embodiments, the DeviceSide component may allow for the user to select an album into which the uploaded media items are added. The list of albums are retrieved from the ServerSide component and displayed to the user for selection. Additionally, the user may choose to create a new album. When a media item is uploaded the ServerSide component checks which album is selected and adds the media to that album. If no album is selected or if the ServerSide component doesn't support selecting of albums, then the media is added to a default album.

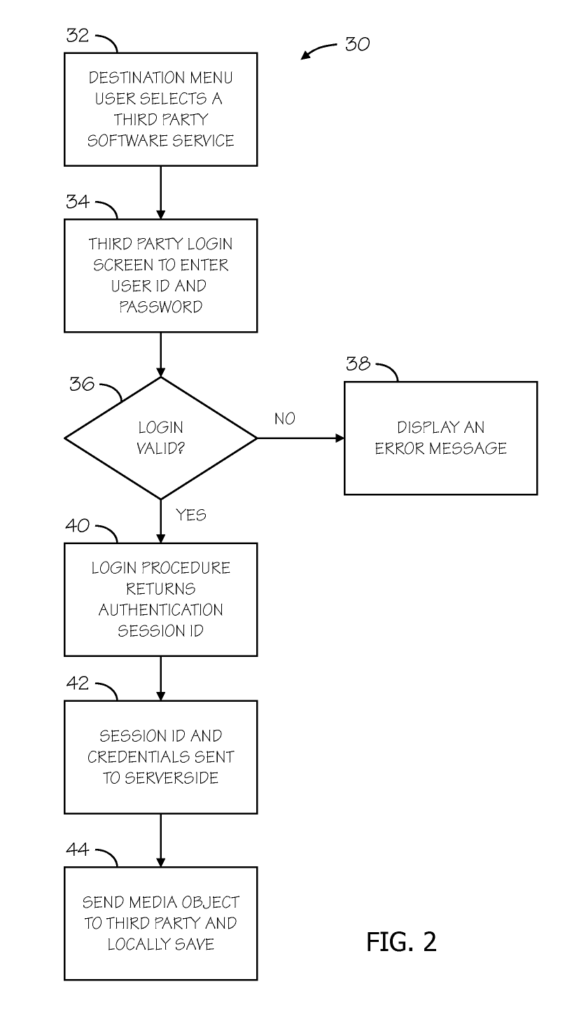

In some embodiments, and as illustrated in process 30 in FIG. 2, the DeviceSide component may allow the user to select other third party destinations for the media items (block 32). These embodiments include a section for configuring and managing these third party destinations. The process to setup each third party destination is slightly different based on how the third party destination api works. But generally when the user selects a destination to setup they are prompted with a login screen where they enter their credentials for that destination site (block 34). The DeviceSide component then sends that information to the ServerSide component that handles connecting to the third party api. If the connection is invalid (“No” branch of decision block 36), then an error message reflecting invalid credentials may be displayed (block 38). If the connection is valid (“Yes” branch of decision block 36), the ServerSide component returns an authenticated session id (block 40). If the login was successful then the ServerSide component saves the session id. When the user uploads new media the session ID and credentials are also sent to the ServerSide (block 42). The ServerSide component then sends the media to the authenticated destinations as well as saves the media (block 44). From the DeviceSide component the user can see which destinations are setup and can enable/disable or logout of the different third party destinations.

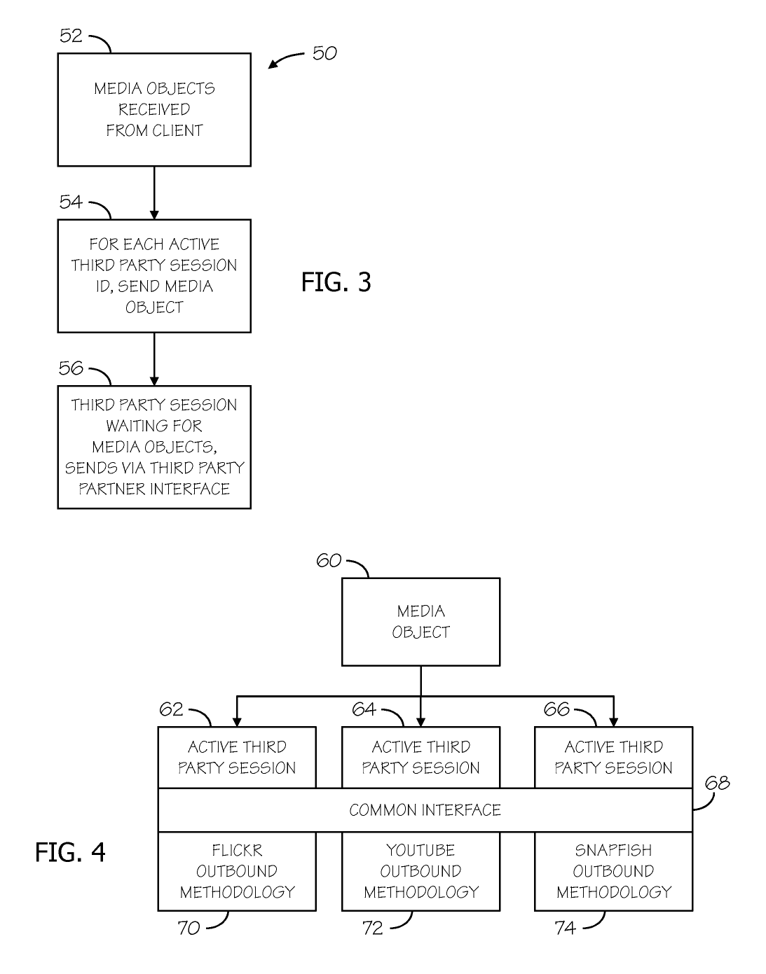

On the Server, when a request comes in from the DeviceSide component, the request is validated by the ServerSide component to determine the identity of the user. If the data in the request is determined to be valid, the raw data from the media object is converted back into an image, video stream, etc. and saved to the hard disk on the server. The ServerSide component also adds information about the media object to the database and links it to the current user. Depending on what the user has set on the DeviceSide component, the media object may be set for public or private viewing. If this is completed successfully, the ServerSide component notifies the DeviceSide component. Additionally, in embodiments where third party software service is selected, and as seen in flowchart 50 in FIG. 3, when media objects are received from the DeviceSide component by the ServerSide component (block 52), the ServerSide component sends the media objects to any active third party session (block 54). Each of the active third party sessions waits for a media object, and when received, sends the media object via a third party interface (block 56). For example, as illustrated in the block diagram in FIG. 4, the media object 60 is sent to each of the active third party sessions 62, 64, 66. The third party sessions access a common interface 68 for retrieving the media object and verification of established connections with the third party service. The media object 60 is then sent to each of the third party services based on specific methodology 70, 72, 74 for that service. Some of the third party services may include FLICKR®, YOUTUBE®, FACEBOOK®, PICASA®, SNAPFISH®, WEBSHOTS®, among others.

In addition to receiving media objects, the ServerSide component also manages against server-side attacks and fraud usage.

The following examples are presented to illustrate embodiments of the present invention and to assist one of ordinary skill in making and using the same. These examples are not intended in any way to otherwise limit the scope of this invention.

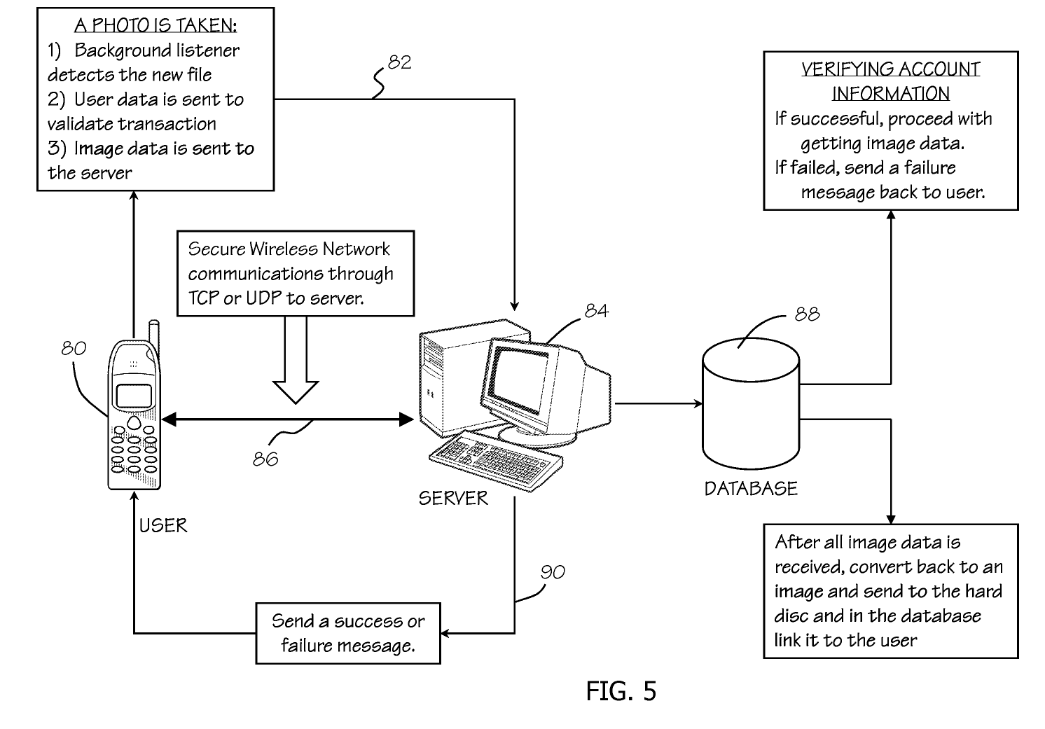

FIG. 5 illustrates an overview of the process set forth above. As described above, a mobile device, such as a cell phone 80, sends a media object, such as a photo, video, or other multimedia message, as indicated by the diagrammatic arrow 82 to a server 84. The media object is sent over wireless communications 86. The server 84 validates the connection, the connection data and the user information being transferred. Once the data transmitted over the wireless communications 86 is validated and deemed appropriate it is converted back to an image and saved to a database 88 where it is also linked to the user. Once the media object is saved, the ServerSide component notifies the DeviceSide component that the file was transmitted successfully as indicated by the diagrammatic arrow 90.

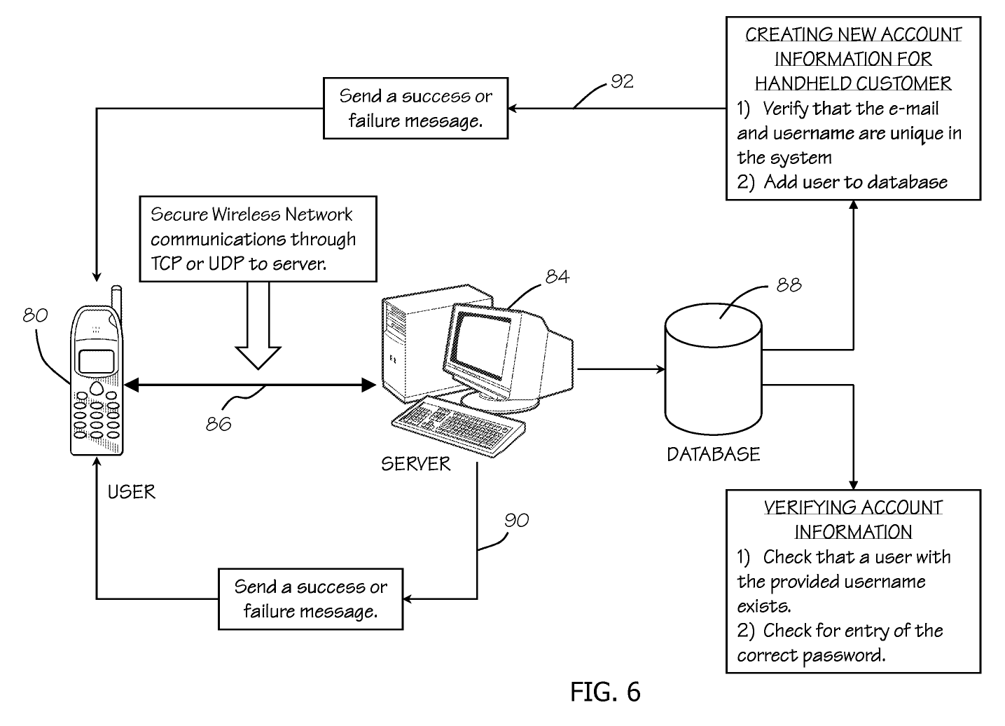

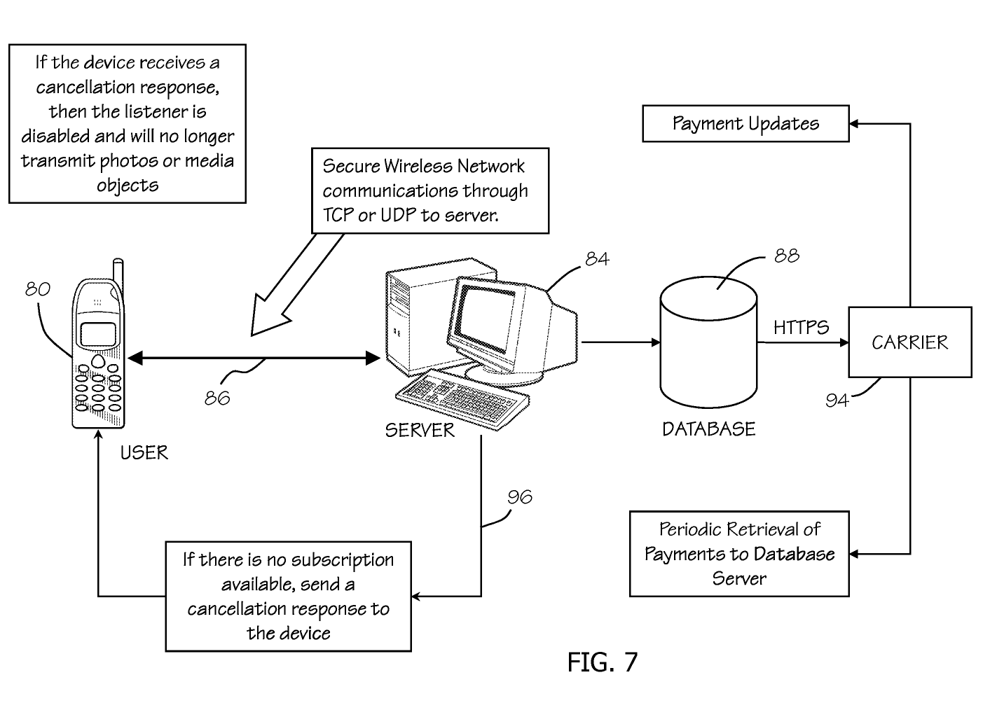

FIG. 6 illustrates the flow into the database during the login and signup processes. The cell phone 80 transmits username, password, and other identifying information over the wireless communications 86 to the server 84. If this is a new account, the ServerSide application executing on the server 84 verifies the information and sends a success or failure message back to the cell phone 80 as indicated by the diagrammatic arrow 92. If successful, the user information is added to the database 88.

FIG. 7 illustrates an embodiment where a subscription is required. In this example, a typical request transmission occurs as described above, but the ServerSide component for the embodiment determines with a carrier 94 through a billing interface if a subscription available. If there isn't a subscription, and to keep the client from constantly transmitting, the ServerSide component transmits a cancellation response indicated by diagrammatic arrow 96 and the ClientSide component prevents the transmission of any media objects and clears the queue as described above.

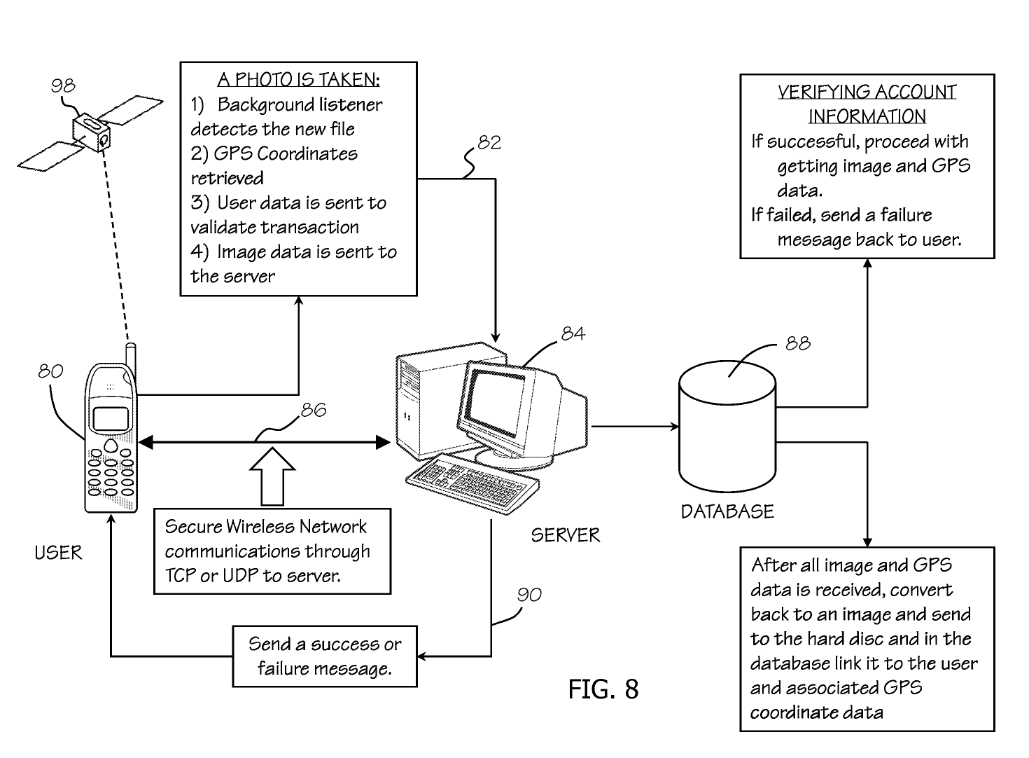

FIG. 8 illustrates an embodiment where the DeviceSide component allows the user to tag their media uploads with the current physical location where the media item was taken. This requires the DeviceSide component and mobile device to have support for retrieving GPS coordinates. If the cell phone 80, for example, has GPS support and the user has chosen to tag the uploads, then after a media item is taken/recorded the DeviceSide component requests GPS coordinates from a GPS system 98 or through a service provider. Due to the expense incurred by requesting GPS coordinates, the DeviceSide component may determine if any coordinates have been previously retrieved and if these coordinates are recent enough. When the coordinates are retrieved, the DeviceSide component sends the coordinates to the ServerSide component on the server 84 over the wireless connection 86 with an identifier for the media object to which they refer. The DeviceSide component may occasionally fail to retrieve coordinates due to the user's location, i.e., if the user is inside a structure that prevents the acquisition of GPS data. If the DeviceSide component is unable to obtain coordinates or fails to receive a complete set of coordinates after a set period of time, the DeviceSide component may cancel the request for the GPS data because the user is likely too far from the location where the media object was taken/recorded.

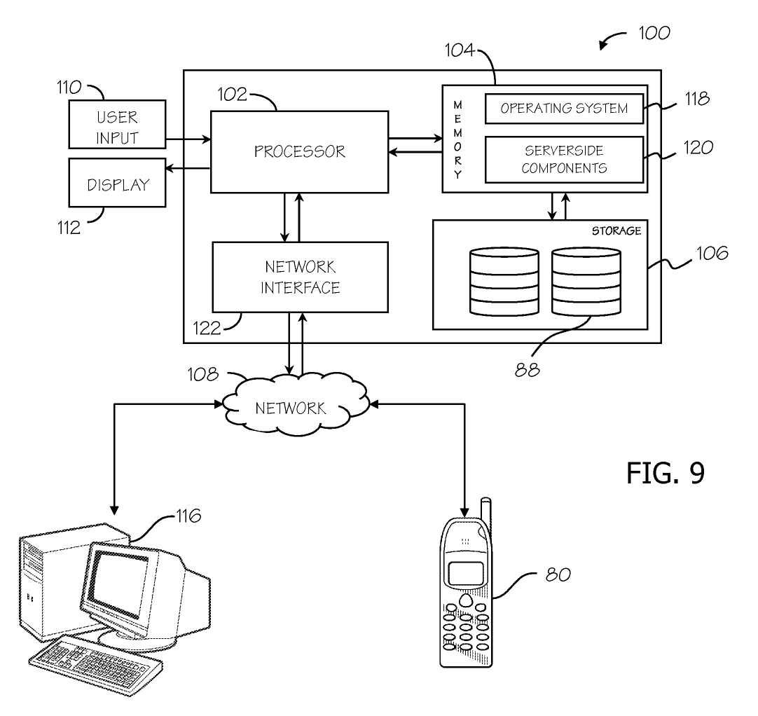

FIG. 9 illustrates an exemplary hardware and software environment for an apparatus 100 suitable for the ServerSide components consistent with the invention. For the purposes of the invention, apparatus 100 may represent practically any computer, computer system, or programmable device e.g., multi-user or single-user computers, desktop computers, portable computers and devices, handheld devices, network devices, mobile phones, etc. Apparatus 100 will hereinafter be referred to as a “server computer” or just “server” although it should be appreciated that the term “apparatus” may also include other suitable programmable electronic devices. Additionally the apparatus 80 for the ClientSide components may be configured similar to server 100.

Server 100 typically includes at least one processor 102 coupled to a memory 104. Processor 102 may represent one or more processors (e.g. microprocessors), and memory 104 may represent the random access memory (RAM) devices comprising the main storage of server 100, as well as any supplemental levels of memory, e.g., cache memories, non-volatile or backup memories (e.g. programmable or flash memories), read-only memories, etc. In addition, memory 104 may be considered to include memory storage physically located elsewhere in server 100, e.g., any cache memory in a processor 102, as well as any storage capacity used as a virtual memory, e.g., as stored on a mass storage device 106 or another computer or device coupled to server 100 via a network 108, such as the Internet or other private network.

Server 100 also typically receives a number of inputs and outputs for communicating information externally. For interface with a user or operator, server 100 typically includes one or more user input devices 110 (e.g., a keyboard, a mouse, a trackball, a joystick, a touchpad, a keypad, a stylus, and/or a microphone, among others). Server 100 may also include a display 112 (e.g., a CRT monitor, an LCD display panel, and/or a speaker, among others). The interface to server 100 may also be through an external terminal connected directly or remotely to server 100, or through another computer 116 or mobile device 80 communicating with server 100 via a network 108, modem, or other type of communications device.

Server 100 operates under the control of an operating system 118, and executes or otherwise relies upon various computer software applications, components, programs, objects, modules, data structures, etc. (e.g. ServerSide components 120) collectively referred to as “objects”. Server 100 communicates on the network 108 through a network interface 122.

In general, the routines executed to implement the embodiments of the invention, whether implemented as part of an operating system or a specific application, component, program, object, module or sequence of instructions, for either the ServerSide component or the DeviceSide component, will be referred to herein as “computer program code”, or simply “program code”. The computer program code typically comprises one or more instructions that are resident at various times in various memory and storage devices in a computer, and that, when read and executed by one or more processors in a computer, causes that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable media used to actually carry out the distribution. Examples of computer readable media include but are not limited to physical, recordable type media such as volatile and non-volatile memory devices, floppy and other removable disks, hard disk drives, optical disks (e.g., CD-ROM's, DVD's, etc.), among others, and transmission type media such as digital and analog communication links.

In addition, various program code described hereinafter may be identified based upon the application or software component within which it is implemented in specific embodiments of the invention. However, it should be appreciated that any particular program nomenclature that follows is merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, APIs, applications, applets, etc.), it should be appreciated that the invention is not limited to the specific organization and allocation of program functionality described herein.

Those skilled in the art will recognize that the exemplary environment illustrated in FIG. 9 is not intended to limit the present invention. Indeed, those skilled in the art will recognize that other alternative hardware and/or software environments may be used without departing from the scope of the invention.

While all of the present invention has been illustrated by a description of various embodiments and while these embodiments have been described in considerable detail, it is not the intention of the inventors to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the inventors' general inventive concept.

1. A method for transmitting media objects from a mobile device to a server, the method comprising:
executing a DeviceSide component on the mobile device that does not require user intervention;
detecting a new media object by the DeviceSide component;
processing the new media object by the DeviceSide Component; and
automatically transmitting the processed media object over a present wireless data connection to a server by the DeviceSide component.

2. The method of claim 1, wherein processing the new media object comprises:
dividing the new media object into a plurality of raw data segments; and
adding header data to each of the plurality of raw data segments.

3. The method of claim 2, further comprising:
retrieving GPS coordinate data for the new media object; and
associating the GPS coordinate data with the new media object.

4. The method of claim 3, wherein the GPS coordinate data is automatically transmitted with the processed media object to the server by the DeviceSide component.

5. The method of claim 2, wherein the automatically transmitting the processed media object step comprises:
transmitting the plurality of raw data segments over the present wireless data connection to the server.

6. The method of claim 1, further comprising:
selecting the present wireless data connection from a group consisting of a TCP connection, SSL based TCP connection, UDP connection, Multimedia Messaging Service (MMS), Simple Messaging Service (SMS), or combinations thereof.

7. The method of claim 1, further comprising:
receiving the processed media object by a ServerSide component on the server;
processing the received media object by the ServerSide component;
transmitting a notification of the received media object to the mobile device ServerSide component; and
storing the received media object by the ServerSide component.

8. The method of claim 7, wherein storing the received media object comprises:
storing the received media object in a preselected album on the server.

9. The method of claim 8, wherein storing the received media object comprises:
establishing a privacy level for the received media object when storing the received media object.

10. The method of claim 9, wherein the privacy level is defined by the user prior to transmitting the media object to the server.

11. The method of claim 9, wherein the privacy level is defined by the album in which the received media object is stored.

12. The method of claim 1, further comprising:
receiving the processed media object by a ServerSide component on the server;
processing the received media object by the ServerSide component;
transmitting a notification of the received media object to the mobile device by the ServerSide component; and
transmitting the received media object by the ServerSide component to a third party location.

13. The method of claim 1, further comprising:
queuing the new media object for processing by the DeviceSide component.

14. The method of claim 13, further comprising:
re-queuing the new media object in response to an indication of an unsuccessful transmission of the processed media object.

15. The method of claim 1, further comprising:
disabling the automatic transmission of the processed media object; and
manually selecting the processed media object for transmission.

16. The method of claim 1, further comprising:
supplying a username and password to the DeviceSide component; and
transferring the username and password to the server prior to transmitting the processed media object.

17. The method of claim 16, further comprising:
preventing transmission of the processed media object in response to receiving an invalid username or password.

18. The method of claim 1, further comprising:
disabling the DeviceSide component.

19. An apparatus comprising:
a processor; and
a program code configured to be executed by the processor for receiving media objects from a mobile device, the program code configured to receive a media object automatically detected and transmitted over a present wireless data connection by a DeviceSide component on the mobile device, process the received media object, and transmit a notification of the received media object to the mobile device.

20. A program product, comprising:
a computer readable medium, and
a program code configured for transmitting media objects from a mobile device to a server, the program code resident on the computer readable medium and when executed by a DeviceSide component on the mobile device without requiring user intervention causes the DeviceSide component to detect a new media object by the DeviceSide component, process the new media object by the DeviceSide component, and automatically transmit the processed media object over a present wireless data connection to a server by the DeviceSide component.
